(19) United States
(12) Patent Application Publication
(10) Pub. No.: US 2009/0038176 A1
(43) Pub. Date: Feb. 12, 2009

(54) Multistage continuous dryer, especially for plate-shaped products

(76) Inventors: Alfred Dotzler, Wangen (DE); Anton Hecht, Lindau (DE)

Correspondence Address: FASSE PATENT ATTORNEYS, P.A., P.O. BOX 726, HAMPDEN, ME, 04444-0726, US

(21) Appl. No.: 11/918,421

(22) PCT Filed: Apr. 11, 2006
(86) PCT No.: PCT/DE2006/000642

§ 371 Date: Oct. 12, 2007

(30) Foreign Application Priority Data
Apr. 13, 2005 (DE) 10 2005 017 187.7

(51) Int. Cl. F26B 25/06; F26B 25/20; F26B 21/00

(52) U.S. Cl. 34/219; 34/236; 34/82

(57) ABSTRACT

The invention relates to a dryer, especially multi-level throughflow dryer for preferably plate-shaped products. The invention essentially aims to achieve a considerable improvement of the drying air guidance and a uniform residual moisture in all products (8) at the end of the drying process, while maintaining the per se known axial blower arrangement, per each dryer zone (1).

The invention relates to a throughflow dryer in a multi-level or multi-tier construction for especially plate-shaped products, with means, especially rollers or belt-like means, for the transport of products within the throughflow dryer, whereby the throughflow dryer has several dryer zones, which comprise a housing and are arranged behind one another in the transport direction of the products, and in which drying air positively circulates in an air circulation method, whereby each dryer zone has at least one central heat source and several axial blowers arranged vertically above one another in a blower stand, which axial blowers convey the drying air in a direct path into inflow openings of nozzle boxes that are arranged preferably pair-wise over and under the transport means of the respective level or tier for blowing the products, and again suck in moisture laden drying air over the at least one heat source.

Throughflow dryers in a multi-level construction with the above mentioned features have been known for a long time; also see “Die richtige Lösung für die Bauplatten-Industrie” (“The Right Solution for the Construction Panel Industry”), prospectus of Lindauer DORNIER GmbH, page 6/7, imprint 12/01/LD/02/99. The drying air sucked in by the blowers has conditions that deviate from one another with respect to the temperature and the moisture of the drying air, over the height of the throughflow dryer, that is to say over the individual levels. As a result, the products that are to be dried in the respective levels of the throughflow dryer are blown with a drying air that comprises differing energy conditions. In that regard it has been found to be a disadvantage of the known throughflow dryer, that the products leaving the throughflow dryer at the end of the drying process comprise a comparatively varying or differing residual moisture. Through measures for the differentiated distribution of the power of the heat source over the height, that is to say over all levels of the throughflow dryer, and through additional installations serving to guide the drying air, a relatively uniform temperature of the drying air in the levels can be achieved and the moisture proportion or content in the regenerated drying air can be corrected or made uniform. These measures are, however, associated with considerable cost expenditures.

From the DE 107 01 426 C2, there is known a multi-level dryer for band-shaped or plate-shaped goods, that consists of a number of dryer zones arranged in a row with one another. A significant differentiating feature between the multi-level dryers mentioned in the prior art and the multi-level dryer disclosed in the DE document consists in that a radial blower is provided for the supply of all dryer levels in the applicable dryer zones instead of several axial blowers as suction and pressure means for the drying air.

It is generally known from the dryer construction, that the radial blower requires a considerably higher energy input than the use of several axial blowers arranged vertically above one another for the circulation of the same volumes of drying air and for the same system resistances. The term system resistances should be understood to encompass, among other things, installations in the dryer zone that act counter to the drying airflow or that form a flow resistance for the drying airflow. In this regard it is also known that axial blowers make possible a comparatively better guidance of the drying air to and away from the products to be dried, because, for example, the inflow openings of the nozzle boxes are located at a relatively small spacing distance away from the pressure area of the axial blowers.

Beginning as a starting point from the known disadvantages of the prior art, the object underlies the invention, to provide a throughflow dryer, especially in multi-level construction, in which a considerable improvement of the drying air guidance and a uniform residual moisture in the products at the end of the drying process is achieved, while maintaining the per se known axial blower arrangement, per each dryer zone. A further object consists in improving the time or duration of operation of the dryer in that the drying air, which is laden with moisture and if applicable with product articles, can be cleaned before its renewed heating.

The first object is achieved according to the invention by the features of the patent claim 1.

The second object is achieved according to the invention by the features of the dependent patent claim 9.

According to the features of the patent claim 1 it is provided
that the housing of each dryer zone of the multi-level throughflow dryer surrounds or encloses a first space or chamber that is equipped with a heat source and that is for the regeneration of the drying air that is guided or circulated back from the product drying process, which chamber is embodied and arranged vertically above a second space or chamber that contains the levels of the dryer zone,
that a suction channel is respectively provided laterally next to each blower stand, which carries axial blowers that are arranged vertically above one another, whereby the suction channel respectively extends over all levels of the dryer zone, and whereby the suction channel connects the first chamber with the suction area of the respective axial blowers through a defined inflow opening for regenerated drying air, and
that the side of the nozzle boxes facing away from the blower stand ends in an air shaft extending over all levels of each dryer zone wherein the air shaft is for moisture laden drying air, which air shaft joins into the first chamber.

The first chamber is divided from the second chamber by an intermediate ceiling, and is closed off relative to the adjoining first chamber of the neighboring dryer zones by insulating bulkhead partitions. The moisture laden drying air from at least two pairs of the nozzle boxes per level is taken up in the above mentioned air shaft, and is directed into the first chamber through the outflow opening present in the intermediate ceiling. In that regard, a predeterminable small portion of the return-flowing air quantity can be withdrawn or directed-off as exhaust air through corresponding suction openings in the wall of the dryer zone and/or through suction openings in the housing of the first chamber, while the remaining larger portion of the return-flowing air quantity is again brought up to the process temperature directly or through a filter arrangement by the heat source arranged in the first chamber. Thereafter, the regenerated drying air is sucked or drawn in by the axial blowers in a directionally oriented manner through the channels extending vertically on both sides next to the blower stand and is once again directed to the inflow opening of the nozzle boxes. At this point it is additionally mentioned that the portion of moisture laden drying air that is withdrawn as exhaust air can be compensated by introducing pre-heated fresh drying air from energy recovery devices into the first chamber.

With the inventive embodiment of the dryer zones of a multi-level throughflow dryer, an improved guidance of the drying air and a more uniform temperature of the drying air in all levels of the dryer zone is achieved, in an advantageous manner, relative to known dryers of this type. The quality of the products that have passed through the drying process is improved.

Through the use of a filter for return-flowing drying air, the soiling of the individual dryer zones can be effectively counteracted; shutdown or stoppage times for the cleaning of the throughflow dryer consisting of a plurality of dryer zones can thereby be reduced.

The invention will be explained in more detail in the following in connection with an example embodiment.

In the drawings:

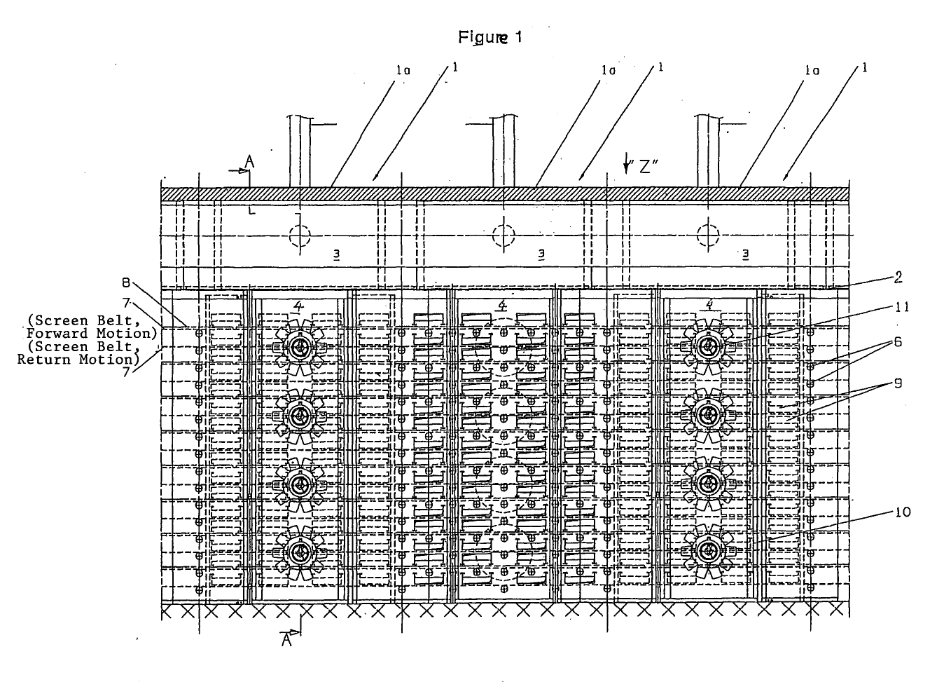

FIG. 1 shows the front view in sectional illustration of three modularly assembled dryer zones of a throughflow dryer in a multi-level construction,

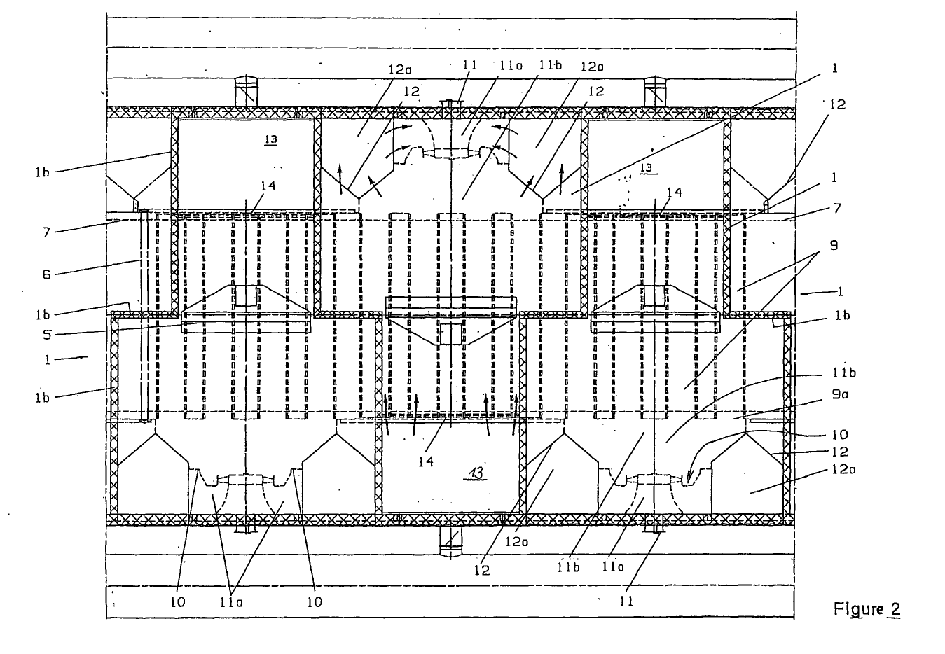

FIG. 2 shows a view “Z” of the dryer zones illustrated in FIG. 1, and

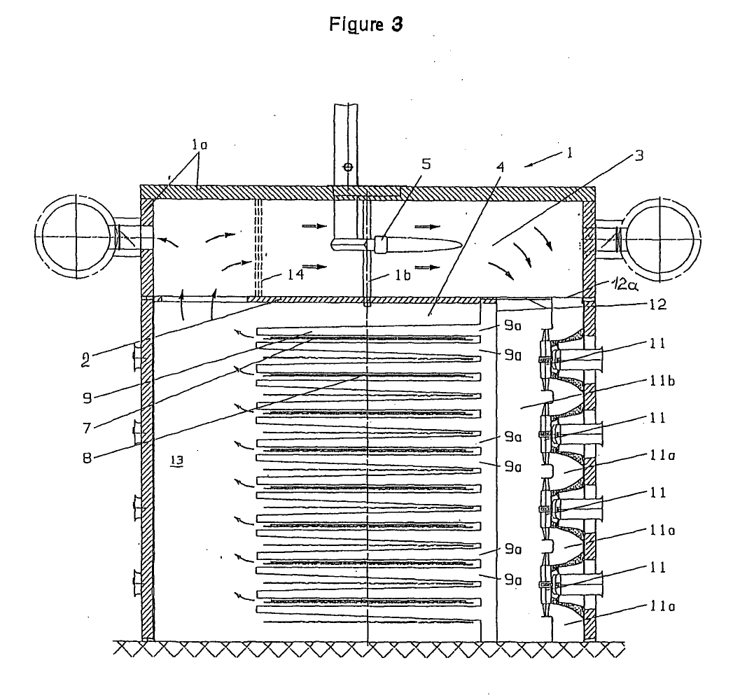

FIG. 3 shows the dryer zone according to the line A-A in FIG. 1.

The FIGS. 1 and 2 show three modularly installed dryer zones 1 of a throughflow dryer consisting of a plurality of such dryer zones. In each dryer zone 1, a housing 1a and an intermediate ceiling 2 divides the dryer zone 1 into two spaces or chambers 3, 4 arranged vertically over one another. The chamber 3 contains a central heat source 5, which can be a gas or oil burner in the present case. In the chamber 4, namely in the chamber below the intermediate ceiling 2, transport means in the manner of screen belts 7 guided on rollers 6 are illustrated on eight levels, whereby these transport means carry the product 8 to be dried. Pairs of nozzle boxes 9 are positioned under and over the applicable screen belt 7. Each dryer zone 1 comprises a blower stand 10, which carries several axial blowers 11 arranged vertically above one another. The axial blowers 11 embody or form a suction area 11a and a pressure area 11b. A suction channel 12 extending over all levels of the dryer zone 1 is provided respectively laterally next to the blower stand 10, whereby this suction channel 12 connects the first chamber 3 with the suction area 11a of the respective axial blowers 11 through a defined inflow opening 12a. The pressure area 11b of the axial blower 11 is embodied or formed axially spaced apart from the suction area 11a, into which pressure area 11b the inflow openings 9a of the nozzle boxes 9 join or discharge, as can be recognized in the FIGS. 2 and 3.

An air shaft 13 is embodied or formed on the side of the nozzle boxes 9 facing away from the blower stand 10 of each dryer zone 1. Moisture laden drying air flows from the individual levels of the respective dryer zone 1 into the air shaft 13, which is open toward the nozzle boxes 9. In turn, the air shaft 13, which extends vertically over all levels of the applicable dryer zone 1, joins or discharges into the first chamber 3, in which the return-flowing moist air is regenerated. In this regard, the term regeneration is to be understood to encompass, for example, the filtering of the drying air, in order to remove possible product dust or particles out of the drying air. Regeneration also means a renewed heating-up, by means of the heat source 5, of the drying air flowing back out of the drying process. A filter 14 integrated in the first chamber 3 serves for the cleaning of the drying air.

1. Dryer, especially multi-level throughflow dryer for preferably plate-shaped products (8), with means, especially rollers (6) or belt-shaped means (7) for the transport of the products within the dryer, whereby the dryer consists of several dryer zones (1) that comprise a housing (1a) and that are arranged behind one another in the transport direction of the products, in which dryer zones drying air positively circulates in an air circulation method, whereby each dryer zone (1) has a central heat source (5) and several axial blowers (11) arranged vertically over one another in a blower stand (10), which blowers convey the drying air on a direct path into inflow openings (9a) of nozzle boxes (9) arranged preferably pair-wise over and under the transport means of the respective level for the blowing of the products, and which again suck-in the moisture laden drying air over the at least one heat source, characterized by the following features:
the housing of each dryer zone (1) encloses a first chamber (3) for the regeneration of the drying air, which chamber (3) is equipped with the heat source (5), and which chamber (3) is embodied and arranged vertically above a second chamber (4) containing the levels of the dryer zone,
a suction channel (12) extending over all levels of the dryer zone (1) is provided laterally next to the blower stand (10), which suction channel (12) connects the first chamber (3) with the suction area (11a) of the respective axial blowers (11) through a defined inflow opening (12a), and
the side of the blower boxes (9) facing away from the blower stand (10) ends in an air shaft (13) for moisture laden drying air, and which air shaft joins into the first chamber (3) for the regeneration of the moisture laden drying air.

2. Dryer according to claim 1, characterized in that the first chamber (3) is separated from the second chamber (4) by an intermediate ceiling (2).

3. Dryer according to claim 1, characterized in that the first chamber (3) formed from the housing (1a) and the intermediate ceiling (2) is enclosed by insulating bulkhead partitions (1b) relative to the adjoining first chamber (3) of the neighboring dryer zones.

4. Dryer according to claim 1, characterized in that the air shaft (13) is embodied over the totality of the levels of the applicable dryer zone (1), and takes up the moisture laden drying air from at least two pairs of the nozzle boxes (9) per level.

5. Dryer according to claim 1, characterized in that the dryer zones (1) are preferably installed in a counter construction relative to one another.

6. Dryer according to claim 1, characterized in that the first chamber (3) of each dryer zone (1) on the one hand is connected with means for the directionally oriented in-flowing of the moisture laden drying air, and on the other hand is connected with means for the directionally oriented out-flowing of regenerated drying air.

7. Dryer according to claim 6, characterized in that the means for the directionally oriented in-flowing of moist drying air consist of at least one air shaft (13), of which the outflow opening joins into the first chamber (3).

8. Dryer according to claim 6, characterized in that the means for the directionally oriented out-flowing of regenerated drying air are vertically extending channels (12) that connect the first chamber (3) with the suction areas (11a) of the axial blowers (11).

9. Dryer according to claim 1, characterized in that a filter arrangement (14) can be arranged in the first chamber (3) between the outlet of the at least one air shaft (13) and the heat source (5).
